(19) United States
(12) Patent Application Publication
(10) Pub. No.: US 2003/0128818 A1
(43) Pub. Date: Jul. 10, 2003

(54) Information transmission system

(75) Inventors: Jason David Kerr, Auckland (NZ); Michael Mayell, Christchurch (NZ)

Correspondence Address: SUGHRUE MION, PLLC, 2100 Pennsylvania Avenue, NW, Washington, DC, 20037-3213, US

(73) Assignee: TELEMESSENGER LIMITED

(21) Appl. No.: 10/246,422

(22) Filed: Sep. 19, 2002

(30) Foreign Application Priority Data
Sep. 20, 2001 (NZ) NZ 514294

(51) Int. Cl. H04M 1/64

(52) U.S. Cl. 379/67.1

(57) ABSTRACT

The present invention relates to a method of transmitting information using an information transmission system adapted to transmit information to a plurality of subscribers from preferably one content provider. The system is adapted to receive at least one electronic transmission of source information from a content provider where this source information incorporates a plurality of subscriber details and content information. The system employed can then initiate a telephone call to each of the plurality of subscribers detailed to deliver a portion of the content information supplied. Preferably the invention described may also be employed within an inspirational message provisioned service, where the content provider can deliver an inspirational message to a plurality of subscribers using a telecommunication network.

### TECHNICAL FIELD

The present invention relates to an improved information transmission system. Such a system may preferably allow information supplied from a single source to be transferred to a large number of users or subscribers relatively quickly and easily. Such a system may also allow for a subscriber to communicate with or send reply messages in response to the information transmitted. Preferably such a system may also run proactively so that the system will periodically contact subscribers directly to provide the information to be transmitted.

### BACKGROUND ART

Information transmission systems can be employed in many different arenas and many different applications. Many different ways of communicating or transmitting information are known.

One of the most common systems employed is written or text documents. Text forms a static media employed by, for example, books, magazines, and some Internet web pages. The information to be transmitted is communicated directly from the text written within the document.

However, written documents have some limitations when it comes to communicating information effectively.

If, for example, the document involved has been used in an education system it would be preferable to automatically obtain some feedback from the reader regarding how well they have understood the information it contains.

Furthermore, to access such information a hard copy of the document must be at hand, or an Internet terminal must be readily accessible.

Literacy is also a barrier as some people do not necessarily have strong written language reading skills, and therefore find it difficult to extract information from written sources.

Furthermore, text documents do not have a proactive implementation, in that a reader must choose to review the document—as opposed to the reader being provided with reminders or prompts to read the document, or a system which reads the document to them.

Written documents are also inevitably read within a short period of time and then discarded or placed into storage until required again. With learning or educational systems, it would be preferable to have a student absorb the information involved in small blocks over a long period of time to give them a better chance of remembering such information.

One other type of information transmission system that is not fully literate or text based is television or video transmissions. Televisions can display a wide range of graphical and text based information that can be of assistance to those who do not have strong reading skills.

However, information transfers sourced from television transmissions again demonstrate similar limitations to those discussed above with respect to text documents. Television transmissions do not provide an effective mobile information transmission system, nor do they allow feedback or communications from a viewer. Furthermore, television transmissions are not proactive in nature and do not provide any reminders or prompts to a viewer that information is being transmitted to them.

These limitations can in effect place handicaps on educational systems. In the main, the above information transmission systems are static and simply provide information on request from a reader or viewer. Invariably, information transmitted is also provided in a single block that can be difficult to remember or absorb efficiently within a short period of time.

An improved information transmission system that addressed any or all of the above problems would be of advantage. A system that could provide reminders or prompts to a user or subscriber that they should be receiving or paying attention to information transmitted by the system, and which could also transmit small blocks of information regularly over long periods of time would be of advantage. A system that also allowed for communications from a user or subscriber back to a source of information, and which also allowed the information transmitted to be customised easily to a particular user or subscriber would be of advantage. Furthermore, a system which was not entirely literate or text based in nature and which therefore did not require a user to have a strong reading skill would be of advantage.

It is an object of the present invention to address the foregoing problems or at least to provide the public with a useful choice.

Further aspects and advantages of the present invention will become apparent from the ensuing description that is given by way of example only.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Indicate the background art which, as far as known to the applicant, can be regarded as useful for the understanding, searching and examination of the invention, and, preferably, cite the documents reflecting such art. (Rule 5.1(a)(ii))

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a method of transmitting information using an information transmission system adapted to transmit information to a plurality of subscribers, wherein the information transmission system executes the steps of:

(a) receiving at least one electronic transmission of source information from at least one content provider, wherein the source information incorporates a plurality of subscriber details and content information, and

(b) initiating a telephone call to each of the plurality of subscribers detailed to deliver at least a portion of the content information supplied.

According to another aspect of the present invention there is provided a method of transmitting information substantially as described above, wherein source information is transmitted using internet protocols and/or facsimile calls.

According to a further aspect of the present invention there is provided a method of transmitting information substantially as described above, wherein at least a portion of the source information is received verbally through a telephone call with the content provider.

According to another aspect of the present invention there is provided a method of transmitting information using an information transmission system adapted to transmit information to a plurality of subscribers, wherein the information transmission system executes the steps of:

(a) receiving text based source information from at least one content provider wherein the source information incorporates a plurality of subscriber details and content information, and

(b) initiating a telephone call to each of the plurality of subscribers detailed to deliver at least a portion of the content information supplied.

According to a further aspect of the present invention there is provided a method of transmitting information substantially as described above wherein at least a portion of said text based content information is translated to audio speech signals prior to portions of said content information being delivered to a subscriber.

According to a further aspect of the present invention there is provided a method of transmitting information substantially as described above, wherein content information includes requests to be posed to subscribers.

According to yet another aspect of the present invention there is provided a method of transmitting information substantially as described above, wherein the information transmission system includes the facility to receive and/or record subscriber responses to requests posed within said content information.

According to a further aspect of the present invention there is provided a method of transmitting information substantially as described above, wherein the content information supplied is composed of a plurality of discreet portions.

According to a further aspect of the present invention there is provided a method of transmitting information substantially as described above wherein the subscriber responses to requests posed controls which portions of the content information are delivered to the responding subscriber.

According to a further aspect of the present invention there is provided a method of transmitting information substantially as described above further characterised by the additional subsequent step of requesting, receiving, and recording task information from a subscriber.

According to another aspect of the present invention there is provided an information transmission system substantially as described above wherein the system is adapted to transmit previously received and recorded task information sourced from a particular subscriber back to said subscriber after a set period of time.

According to yet another aspect of the present invention there is provided an information transmission system substantially as described above wherein subscriber details include identity information for a plurality of subscribers.

According to yet another aspect of the present invention there is provided an information transmission system substantially as described above wherein subscriber details include names and telephone numbers for a plurality of subscribers.

The present invention relates to a method of transmitting information and an associated information transmission system employed by such a method. Such a methodology and system is preferably used so that information sourced from a single content provider can be distributed to a plurality of separate subscribers easily, quickly and automatically.

Preferably an information transmission system provided in accordance with the present invention employs at least one telecommunications network to deliver information to subscribers. Such networks may include physical land line based systems in addition to cellular telephone networks, and any other type of communication network which can be interfaced with a telecommunications device.

In a preferred embodiment the information transmission system may include at least one computer system loaded with software adapted to perform or assist in the performance of the methodology of the present invention. Such software may allow for the reception of information sourced from a single content provider, and may facilitate the transmission of such information out to a plurality of subscribers nominated by the content provider. Furthermore, such software may also facilitate the provision of additional functions such as receiving feedback or responses from subscribers to information transmitted to them.

Those skilled in the art should appreciate that any number and type of computer systems may be employed in conjunction with the present invention to achieve these aims. Furthermore, it should also be appreciated that the software to be run on such a computer system or computer systems will vary depending on the hardware employed, operating systems used and also the configuration of telecommunications networks over which information is to be transmitted to subscribers.

Preferably the information transmission system receives source information from a single content provider only. The present invention may be employed to distribute at least a portion of this source information to all subscribers detailed or nominated by the single content provider. Reference throughout this specification will also be made to the present invention being employed by a single content provider. However, those skilled in the art should appreciate that the present invention may also be adapted to support multiple content providers and reference to the above only throughout this specification should in no way be seen as limiting.

Preferably a content provider initially transmits text based source information to the information transmission system. Such text may be delivered in any number of ways ranging from physical delivery of a printed document, through to facsimile, e-mail, or Internet protocol transmissions of such text. For example, in a preferred embodiment the information transmission system may provide or host a web site which posts text fields within which such information can be entered, or alternatively may be adapted to upload electronic computer files.

Reference throughout this specification will also be made to text based source information being supplied to a computer system using a web site and being transmitted using Internet protocols. However, those skilled in the art should appreciate that other methods for delivering text based source information to the information transmission system may also be employed and reference to the above only throughout this specification should in no way be seen as limiting.

For example, in one alternative embodiment at least a portion of the content information supplied may be in audio format, such as speech or sounds transmitted from a content provider. Alternatively content information may encompass other types of information which do not necessarily employ text based encoding schemes. Those skilled in the art should appreciate that content information may be encoded and formatted in any form which allows transmission from a remote content provider. Preferably the coding employed may be of an electronic form.

In a preferred embodiment the source information received by the transmission system includes content information, where at least a portion of which is to be delivered or transmitted to the plurality of subscribers. Content information may encompass any types of subject matter or information depending on the requirements of the subscribers involved. The content information supplied can also be categorised or organised into a number of portions or elements, where all portions of the content information need not necessarily be delivered to a single subscriber.

In a preferred embodiment source information may also incorporate a plurality of subscriber details. Subscriber details may identify each of the plurality of subscribers to which information is to be transmitted, and also give details relating to how such information is to be delivered or transmitted to each subscriber.

Reference throughout this specification will also be made to source information received from a content provider also including details for a plurality of subscribers. However, those skilled in the art should appreciate that in some embodiments source information from a content provider may simply consist of content information to be delivered to subscribers. In such instances the content provider may already have delivered or supplied the details of the subscribers involved to the information transmission system. This allows any content information supplied to be automatically distributed out to these subscribers without the need to re-specify subscriber details every time source information is delivered.

In a preferred embodiment the subscriber details incorporated into the source information may include the identity information for each subscriber to have information delivered to them. This identity information may include names, addresses and other details particular to individual subscribers or groups of subscribers.

Preferably, subscriber details may also include a telephone number on which the subscriber can be contacted and through which information can be transmitted to the subscriber. As discussed above, information may be delivered to subscribers over telecommunications networks through, for example, landlines or cellular telephones.

In a preferred embodiment the information transmission system may also include an information storage facility such as a database. Such a facility may record and store information pertaining to each of the subscribers who are transmitted information using the present invention. Such a database may build up information not just on the contact particulars of subscribers, but may also record information relating to the likes, dislikes, and interests of subscribers, as well as recent events in subscribers lives. Such information may be sourced directly from subscribers or alternatively may be supplied by the content provider involved.

In a further preferred embodiment subscriber detail information may also include times at which the subscriber has nominated that they will be receptive to information being transmitted to them. The subscriber may provide a schedule of times that they would be reasonably sure they have the time to receive and pay attention to information transmitted to them.

In some embodiments elements or portions of the content information to be delivered may also have been previously selected by the particular subscriber involved, and also in some instances may be composed of content generated or customised by such a subscriber. For example in one instance a subscriber registration process may be completed prior to the use of the present invention, where a subscriber can provide specific details regarding the type of content they would like delivered depending on their own preferences and desired goals or requirements. In a further embodiment the subscriber may also be given the facility to incorporate for delivery date or time specific reminders or periodic recurring messages which they have formatted themselves. This type of content can be delivered in conjunction with the present invention to allow a subscriber to provide themselves with highly customised messages or information at a later date.

In a further preferred embodiment a subscriber may be given some control over the timing at which specific portions of said content information are delivered in addition to the actual makeup of the content information through access to an internet based user interface. This internet based or web based interface facility can be used to register a new subscriber with the system and obtain specific details from them regarding their preferences and requirements with respect to content information. Furthermore, the interface provided may also in some instances display a stack or queue of specific portions of content information to be delivered to a subscriber in addition to timing information regarding when the specific portions of content information are to be delivered. The ordering of this stack or queue and the timing of content information delivery may then be altered or modified by a subscriber using such a web interface.

Preferably, once the information transmission system has received the content information it requires, it may then initiate telephone calls to each of the subscribers detailed by the content provider. Preferably the timing of such telephone calls may be made to suit the schedules and requirements of the subscribers involved. For each block of source information supplied the transmission system may make a single phone call to each subscriber detailed. The phone call initiated by the transmission system can then be used to deliver information to each subscriber.

Preferably the telephone call initiated by the information transmission system may be used to deliver at least a portion of the content information involved to a subscriber. Some or all of the content information may be delivered depending on the particular subscriber involved and how they interact with or respond to the information transmission system.

Preferably the text based content information supplied by a content provider may be translated into audio or speech signals prior to delivery to a subscriber. In such instances content information may simply be “spoken” over the telephone by the transmission system to the subscriber, eliminating the need for the subscriber to read any information or to have good literacy skills. Furthermore, providing audio communications with the subscriber makes it easier for the subscriber to intuitively interact with the system.

In a further preferred embodiment content information transmitted through a telephone call to a subscriber may also be retransmitted to the same subscriber in text format using an alternative transmission medium. For example in one alternative embodiment a text transcript of the contents of the telephone call completed may be e-mailed, faxed or printed and subsequently delivered to a subscriber after the call involved has been completed. Those skilled in the art should appreciate the entire transcript of the phone call or alternatively portions only of the content delivered may be subsequently retransmitted in accordance with the various embodiments of the present invention.

In a preferred embodiment content information to be delivered to subscribers may include requests to be presented to subscribers. In such instances the information transmission system may also include the facility to record subscriber responses to such requests and to complete further actions in relation to the same.

In a preferred embodiment subscribers may provide vocal or audio responses to requests proposed within said content information. These audio responses may then be received by the transmitting system and may be used for example, to control what content is delivered to the subscriber involved or alternatively may be recorded for use at a later time.

In a further preferred embodiment the information transmission system may also include or be associated with voice recognition software. Such software may be provided with responses or communications from subscribers and can be used to translate these responses into text format responses.

However, those skilled in the art should appreciate that the use of voice recognition software should not be considered entirely essential for the implementation of this feature of the invention. For example, in one alternative embodiment, if the subscriber is employing a telephone with a keypad which generates distinctive response tones relating to which number of the keypad the subscriber presses, key presses may be employed as responses to queries. For example, in some instances the system may pose a question to the subscriber with three essential answers being listed to the subscriber as responses they can make. By pressing the keypad numbers one through three the subscriber may then respond to such a query.

Preferably, the responses made by subscribers to queries within the content information may in turn be employed by the transmission system to control what other portions of the content information are to be delivered to the subscriber. The subscriber may be posed a series of queries regarding particular types of information or topics which they would like to receive further information on, and based on subscriber responses, the transmission system may then deliver such information.

In a further preferred embodiment the content information may include a request to a subscriber to provide the system with task information. Task information may consist of or include details of a task or goal that the subscriber has assigned themselves to complete within the short, medium or long term. Preferably the information transmission system may also receive and record task information provided by subscribers in response to such requests.

In a further preferred embodiment the information transmission system may also be adapted to replay the task information provided by the subscriber at a later date once the subscriber has had a chance to attempt the task involved. The system may also query the subscriber regarding whether the tasks involved have been completed and may record the response of the subscriber. The subscriber responses may then be collated to give a performance indicator back to the subscriber regarding their successes to date or over a set period of time.

In this embodiment a performance indicator calculated may also be used as a factor to determine what new content information is to be delivered to the particular subscriber involved in future. If for example the subscriber is having trouble achieving the goals they have assigned to themselves new content may be delivered to inspire and further motivate the subscriber in light of the previous failures.

In a preferred embodiment the content delivered to the subscriber previously may also be made available to the subscriber at a later date on demand. For example in one preferred embodiment content information previously delivered to a subscriber may be accessed by a subscriber using an interact web page or web based interface facility. In such an embodiment the subscriber may access text transcript files or alternatively audio recording files of content information delivered to them at previous times.

In a further preferred embodiment such an internet based content information retrieval system may also make available recordings of the subscriber's prior responses to requests made to them. Recordings may be made of, for example, task information or alternatively information volunteered by a subscriber regarding their success in completing the tasks involved. Furthermore the present invention may also provide the facility for a subscriber response to be of a general form only, allowing a subscriber to dictate notes or information to the system for later retrieval using such a web based interface. For example, in some instances the content information delivered may incorporate a request for a subscriber to record or deliver any further general notes or information they may want to retrieve and consider at a later date.

In some instances the present invention may also include the facility to deliver transcripts or recordings of content information delivered and/or a particular subscriber's responses to either the subscriber or persons nominated by the subscriber being authorised to receive said information. For example in some instances a web based interface may be provided to all authorised parties which can be used to access this information, data CDs may be delivered to all parties or alternatively follow on telephone calls may be made to any parties other than the subscriber who are to receive such information.

According to a further aspect of the present invention there is provided a method of providing an inspirational service using content supplied from a content provider to a plurality of subscribers, characterised by the steps of;

(i) instigating a call to a subscriber, and

(ii) delivering at least one inspirational message to said subscriber, wherein said inspirational message or messages are sourced from information provided by said content provider.

According to a further aspect of the present invention there is provided a method of providing an inspirational service substantially as described above, further characterised by the additional subsequent step of

(iii) requesting goal specific information from the subscriber called, and

(iv) recording the subscriber's response to said request for goal specific information.

According to yet another aspect of the present invention there is provided a method of providing an inspirational service substantially as described above, further characterised by the additional subsequent step of;

(v) delivering the subscriber's recorded response to a request for goal specific information back to said subscriber at a later time.

The methodology and transmission system described above may be employed in a wide range and number of different applications depending on the needs of the subscribers involved and the content provider who is to supply the information to be transmitted. Those skilled in the art should appreciate that actual application for the present invention will determine who participates as subscribers and content providers.

For example, in one preferred embodiment the present invention may be employed as part of a self-help or motivational system. Numerous individual subscribers may participate in such a venture through having motivational or goal setting content information transmitted to them by a single motivational life coaching person or organisation.

In such an application, the content provider (being either a person or organisation) can supply text based motivational information or messages to the system with a list of subscriber identities and phone numbers to be contacted. The system may then initiate a phone call to each of the subscribers in turn to deliver the motivational message supplied to the system to each subscriber.

Further functions may also be provided by the system in such an application such as, for example, recording task or goal based information requested from a subscriber, and also the playing back to a subscriber of prior task information supplied to the system. A subscriber may also provide feedback to the system in response to queries posed to the subscriber such as, for example, queries relating to the content or type of information which the subscriber currently holds an interest in or would like to hear more about.

Other applications are also envisioned for the present invention aside from self-help or motivational applications. For example, the present invention may also be used to co-ordinate communications between teams or groups of people, where at any one point in time a team member acts as the content provider for the system with the remaining team members forming the subscribers who have the same content information transmitted to them using the present invention.

The present invention may also be used to provide, a remote data collection system where subscribers are queried and have certain types of information requested from them. The system may then record the subscribers' answers and collate this information over all the subscribers called.

The present invention may also be used in an educational role to regularly deliver small blocks of content information to a large number of students. Queries or quizzes may also be posed to subscribing students using the present invention where the students' answers are recorded and analysed to give the students some feedback with regard to their performance to date.

The present invention provides many potential advantages over existing information transmission systems.

The present invention can be implemented in a proactive scheme which directly initiates and connects telephone calls to all subscribers, as opposed to subscribers having to consciously decide to seek out the information to be delivered.

The present invention can also be implemented to deliver information in an entirely audio format, allowing information to be delivered effectively to persons with limited or poor language reading skills.

The present invention may also allow a single content provider to deliver or transmit information automatically and easily to a large number of subscribers. Such a content provider need only provide the system with subscriber details and the content to be delivered.

The present invention also provides an effective mobile information transmission system where telephone calls are placed to mobile cellular telephones

Furthermore, information may be delivered to subscribers in small blocks at regular intervals over a long period of time, thereby increasing the likelihood of subscribers remembering the information sent to them.

### BRIEF DESCRIPTION OF DRAWINGS

Further aspects of the present invention will become apparent from the ensuing description which is given by way of example only and with reference to the accompanying drawings in which:

FIG. 1 shows a block schematic diagram of the components and entities involved in an information transmission system and associated methodology as implemented in accordance with the preferred embodiments of the present invention; and

FIG. 2 shows a flow chart of steps executed in a method of transmitting information in accordance with a further embodiment of the present invention.

FIG. 3 shows a system architecture for the hardware and associated software employed with the present invention in a preferred embodiment, and

FIG. 4 shows a logical flow of information through various components of the system discussed with respect to FIG. 3 and the logical location of each component, and

FIGS. 5-8 show a series of sequence diagrams illustrating processes executed by the system discussed with respect to FIGS. 3 and 4.

### BEST MODES FOR CARRYING OUT THE INVENTION

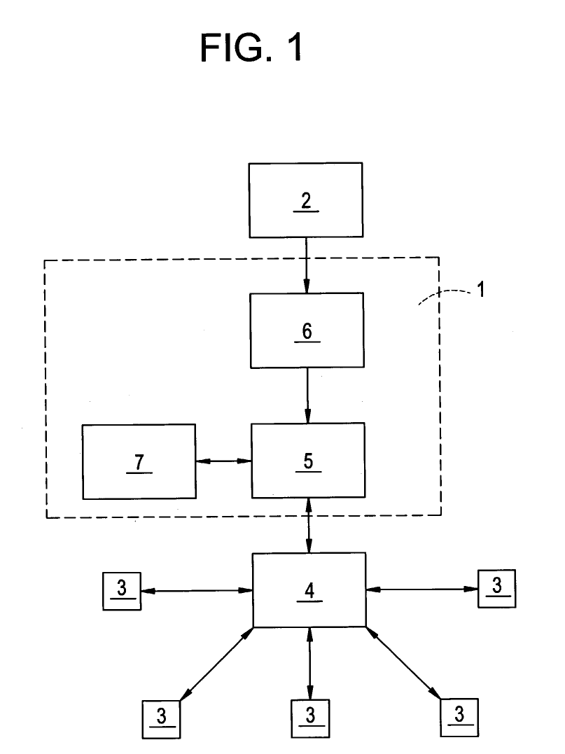

FIG. 1 shows a block schematic diagram of the components and entities involved with an information transmission system and associated methodology as implemented in accordance with a preferred embodiment.

In the embodiment shown the system 1 interacts with a single information content provider 2 to distribute substantially the same information to a number of subscribers 3. Each of the subscribers 3 is contacted through, or has information delivered to them by a telecommunications network, (indicated by reference 4).

The information transmission system 1 is composed of a primary process management computer system 5 linked to a web site or web hosting computer system 6 and a further computer system hosting a database 7 of subscriber information. Those skilled in the art should also appreciate this particular architecture of computer systems need not necessarily be considered essential to the implementation of the present invention. The web hosting, process management, and database activities completed may be run through a single computer system or more than three separate computer systems if required in other embodiments.

The system shown is used to provide, for example, a self help or subscriber motivation application. The content provider 2 generates motivational messages or provides educational information as content information to be provided to the system 1 using the web host 6. This information is supplied in text format and also includes the contact details and identities of each of the subscribers 3 to be supplied with such information. Alternatively, in some instances, a content provider may simply give the names of subscribers and their phone numbers may be extracted from the database system 7.

The text based content information supplied is then be converted into vocal or audible speech signals by the processing computer system 5. Once this conversion has been completed the system 1 instigates a number of separate phone calls to each of the subscribers 3 using the telecommunications network 4.

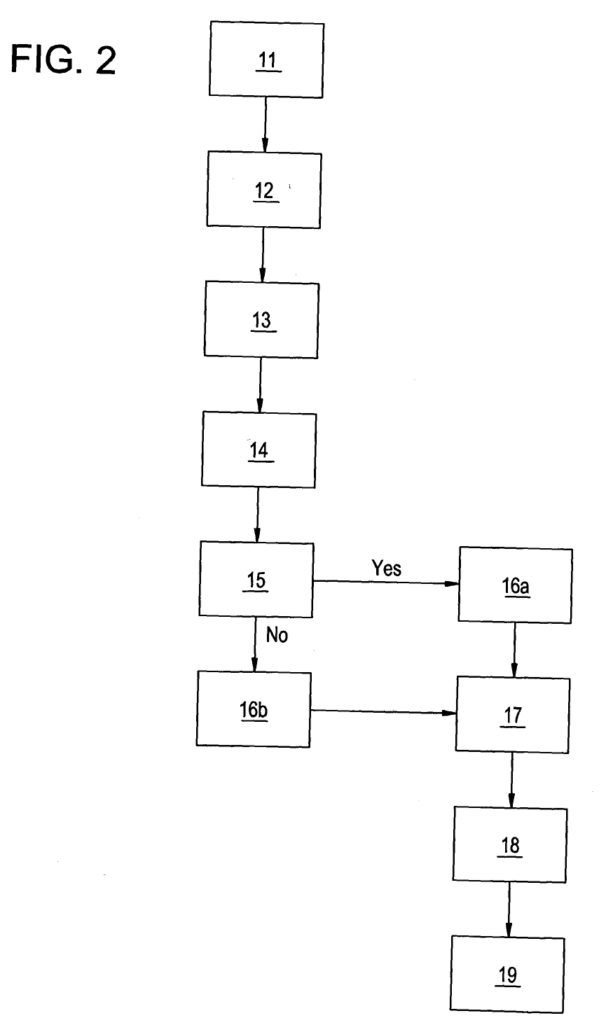

FIG. 2 shows a flow chart of the steps executed and communications made during a phone call instigated by the system 1 to a subscriber 3 as shown with respect to FIG. 1.

As a first stage 11 before the call is connected the system receives content information from a content provider. During the following stage 12 this content information is translated from a text-based format into an audible speech based signal. Once this work has been completed the system will instigate a call to a particular subscriber at stage 13.

After the subscriber has answered the call made to them, the system will deliver a first introductory portion of the content information to be supplied. This introductory content also incorporates a query or question to be answered by the subscriber. The subscriber's response to such a query will then determine the next stage completed and therefore the follow on content information to be delivered to the subscriber.

In the instance shown the information transmission system includes voice recognition software which will recognise a yes or no answer spoken by a subscriber into their telephone. If a yes answer is detected step 16a is executed delivering a different portion of content information than if a no answer is spoken, and step 16b is executed.

After delivery of this second portion of information, at stage 17 the system prompts the subscriber with regard to prior goals or tasks the subscriber has set to themselves, and will play back a previous recording of the subscriber giving details of the goal they have set. The system then prompts the subscriber for an answer regarding whether the goal or task has been completed, and based on the subscriber's response will in turn communicate to the subscriber summary information regarding all prior tasks attempted by the subscriber which the subscriber has advised the system of.

At the next stage 18 of the communications methodology the system will then request that the subscriber provide further information regarding a new goal or task to be completed. At this stage the system will record the subscriber's voice for future playback as the subscriber describes the new task or goal they are setting themselves.

As the last stage of this process the system will confirm with the subscriber that their new goal has been recorded and will terminate the telephone conversation.

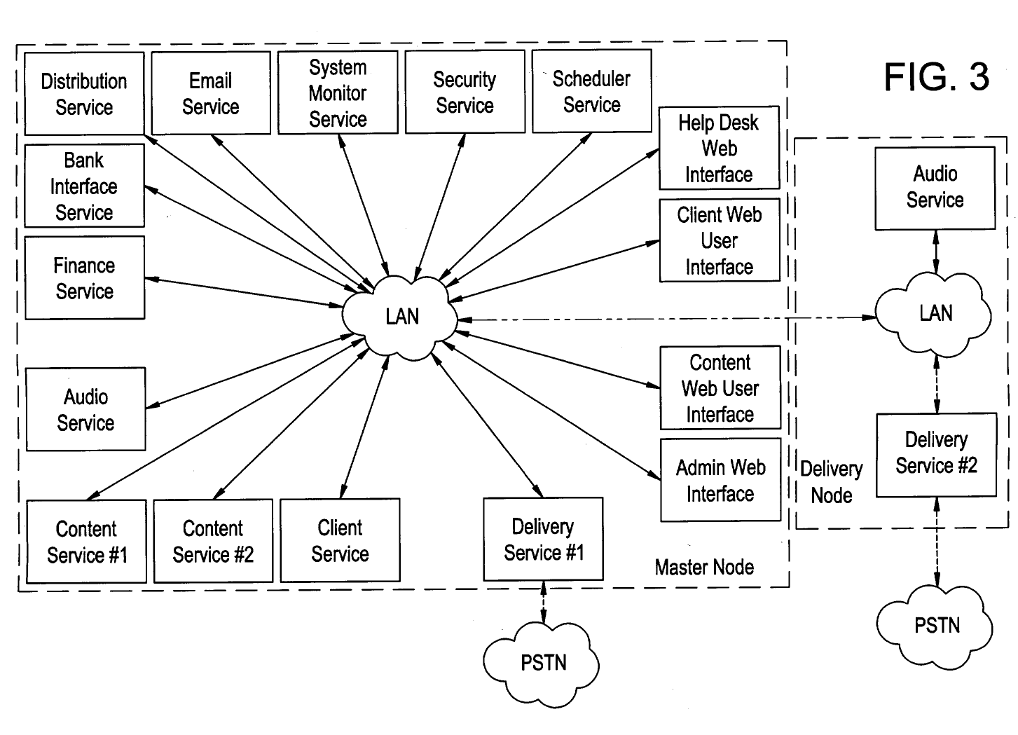

FIG. 3 shows system architecture for the hardware and associated software employed with the present invention in a preferred embodiment.

The system architecture is based on a network of regional sites that operate independently. Each regional site is made up of a cluster of nodes that operate over a wide geographic area.

The design allows for fail over protection so that if any part should fail, the rest of the system can function all but in a restricted manner until services are restored.

A key aspect of the design is to allow multiple content channels and multiple types of customers to utilise the same delivery mechanism.

A regional site is made up of multiple nodes operating in a star like formation. Each site can deliver multiple types of content channels to multiple user bases within the regional.

Regional boundaries will be defined by content type and audience rather then geographic location. Although geographic location will naturally group audiences (by language) and content (by culture).

A site is made up of 1 master node and multiple delivery nodes. For each regional site there will be a single controlling node that contains the master database, web server, and web services that make up the system. All delivery nodes will communicate directly with the Master node. Master nodes will communicate to other master nodes. These are geographically distributed across a region to reduce telecommunication costs and offer redundancy. These nodes are responsible for connecting to the PSTN and delivering content to the customer phones.

Each of the elements shown with respect to FIG. 3 are also discussed below;

Admin Web Administration of the system will be via a web interface. This Interface will enable remote configuration and allow for the wider system

| | |
|---|---|
| Client Web | Clients will access the system via a web-based |
| | interface where |
| Interface | they can monitor, configure service, and alter |
| | content selection. Services can also be extended to a |
| | desktop client and WAP phones. |
| Content | Content management will initially be web based with a |
| | view to |
| Management | moving to a desktop application to enable easy |
| Web | integration with other products. Content managers can |
| Interface | load, edit and publish content in the systent |
| Help Desk | Help desk web interface will allow staff monitoring the |
| Web | system to maintain subscriber records and answer |
| Interface | subscriber questions. Help desk operators will have |
| | access to selected subscriber details and transaction |
| | history. |
| Email | This service will manage emails to and from subscribers. |
| Service | Were notification to the subscriber is required this service |
| | will generate the email and update the subscriber records. |
| | Incoming emails will be scanned and where appropriate |
| | tagged for attention. Emails will be matched to |
| | subscribers where possible. |
| Security | This service will manage all user authentication and |
| Service | access permissions within the system. |
| Scheduling | This service will schedule any event that is required in |
| | the future. |
| Service | When an event is due this service will start the required |
| | process and ensure successful completion of the event |
| | Where multiple events are queue for the same resource |
| | the scheduler will level events across similar resources. |
| System | This service will monitor the whole system to ensure |
| Monitor | integrity and notify maintenance staff where intervention |
| Service | is required. |
| Distribution | This service is responsible for propagating data to |
| Service | remote nodes of the system. An example would be where |
| | Audio files are updated as pan of content changes. |
| | These files will be distributed to remote delivery nodes. |
| Audio | This service provides all audio files associated with |
| Service | content and user recordings. Content will be replicated |
| | across system nodes to reduce network traffic. |
| Delivery | This service is responsible for packaging all information |
| service | required for a phone call, managing the interface to the |
| | LYR system and processing the results of a call. There |
| | will be multiple delivery services distributed by |
| | geographic location to reduce call costs. |
| Finance | This service is responsible all financial related |
| service | information, This includes billing, accounting, |
| | reporting and auditing. |
| Bank | This service is responsible communicating with external |
| Interface | banking systems for credit card payment authorisations, |
| service | fund transfers and transaction reconciliation. |

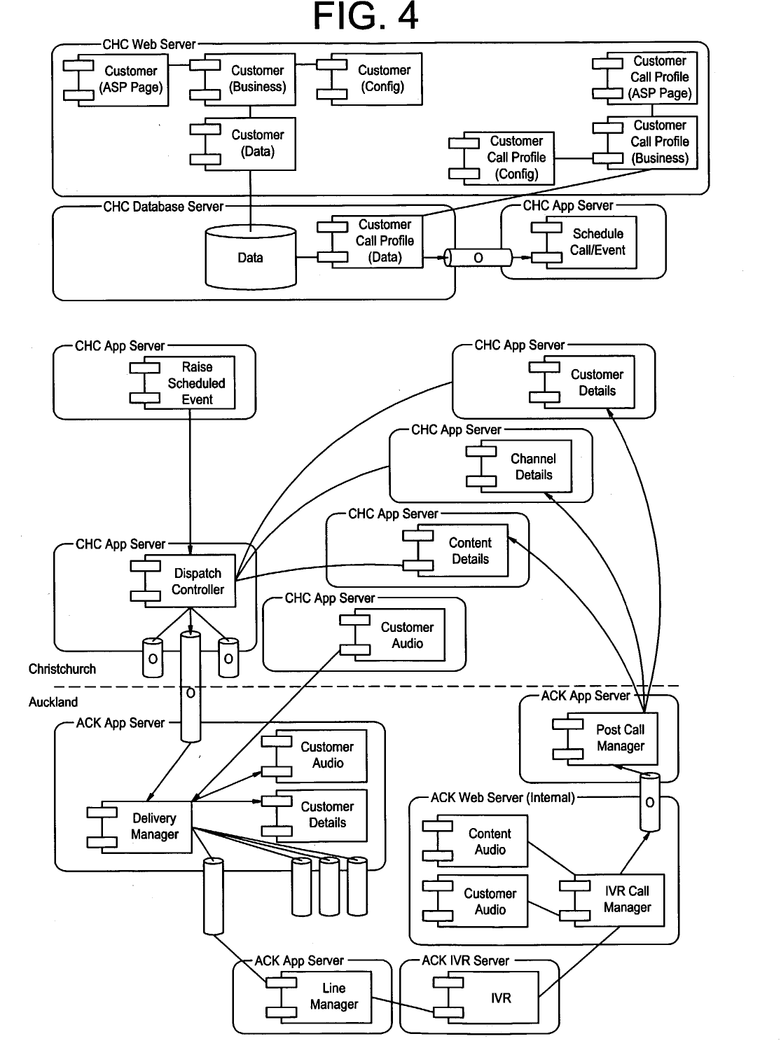

FIG. 4 shows a logical flow of information through various components of the system discussed with respect to FIG. 3 and the logical location of each component above.

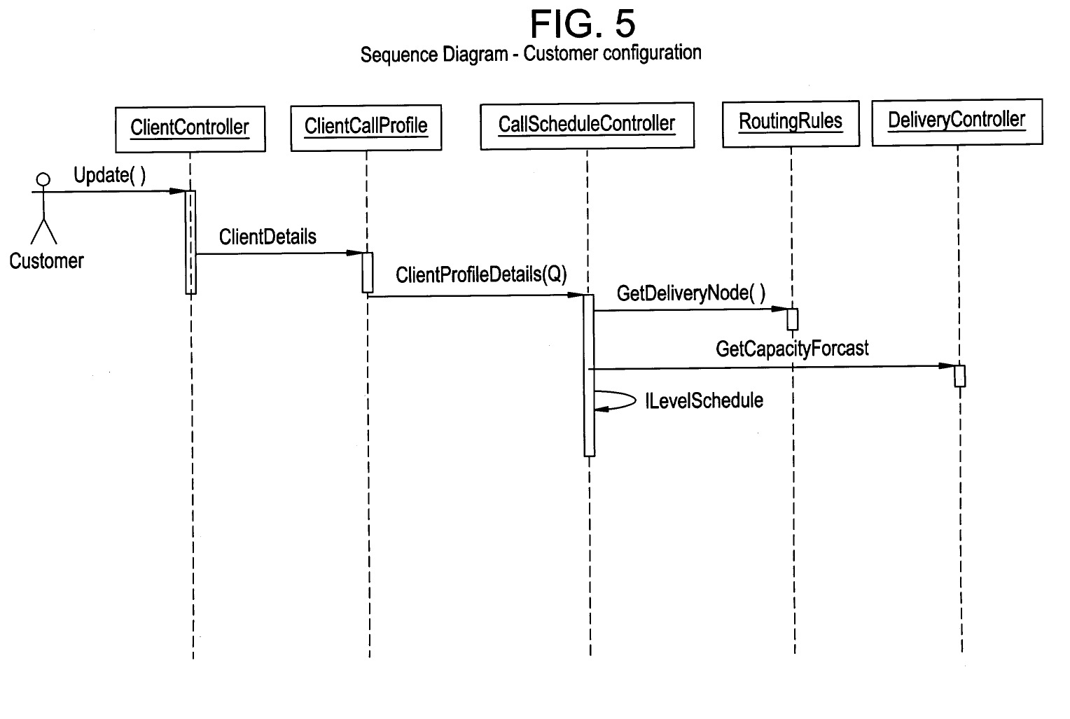

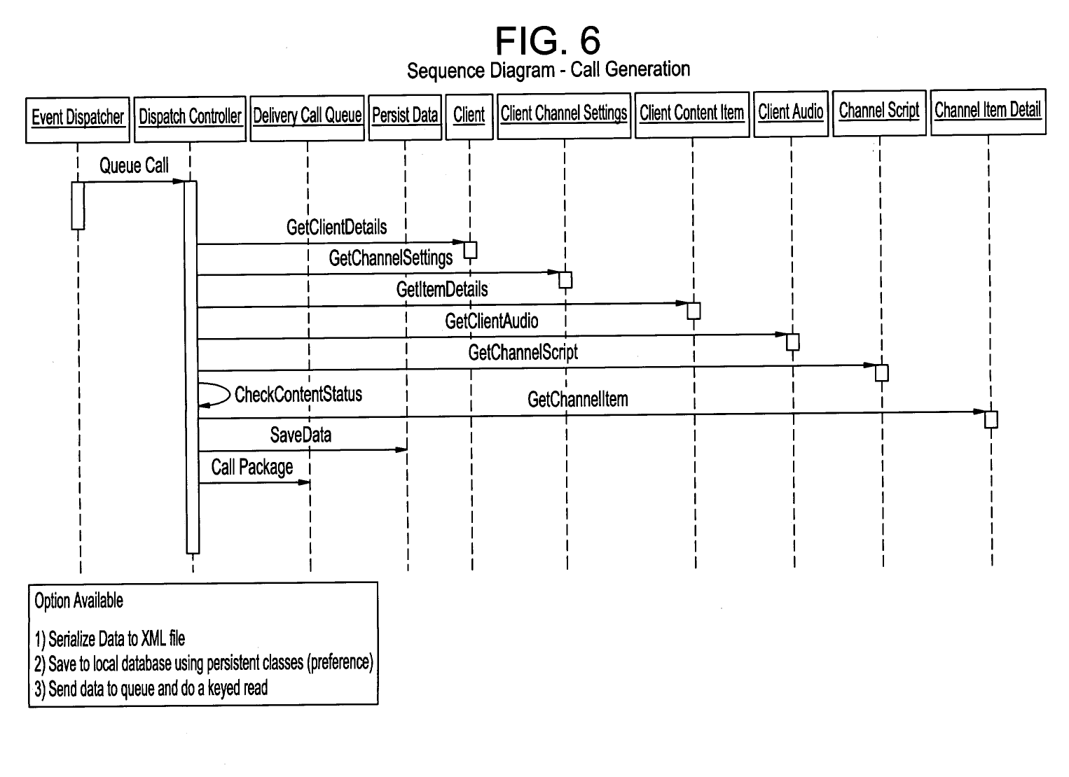

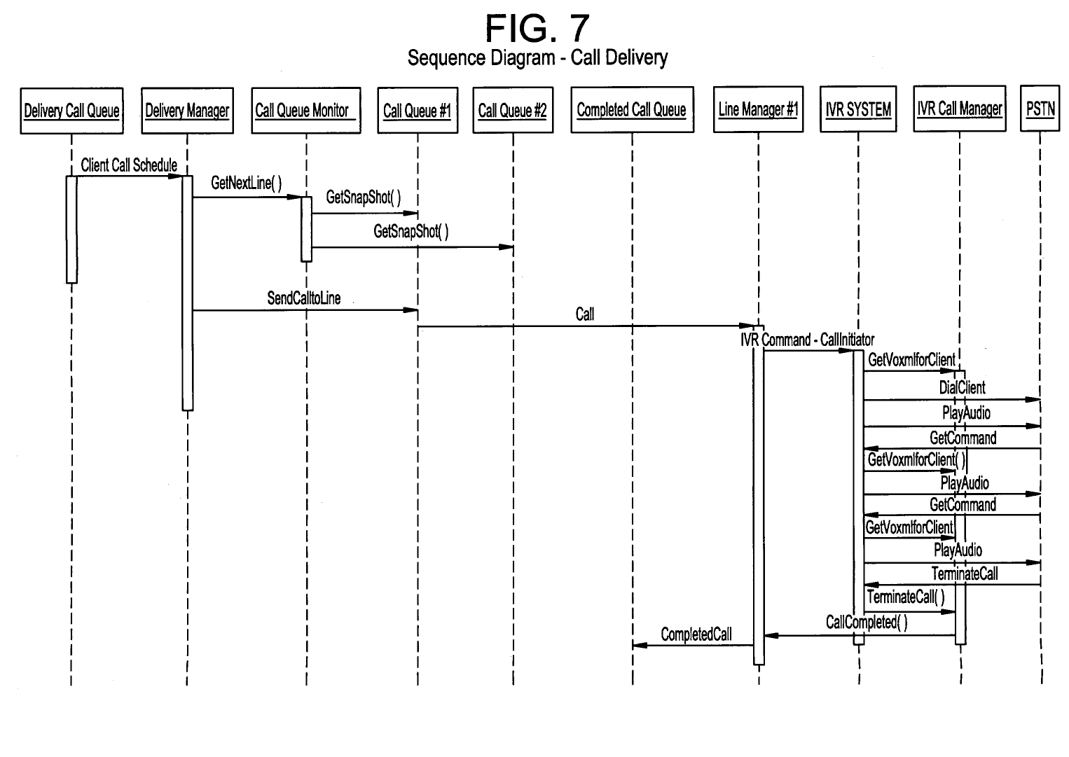

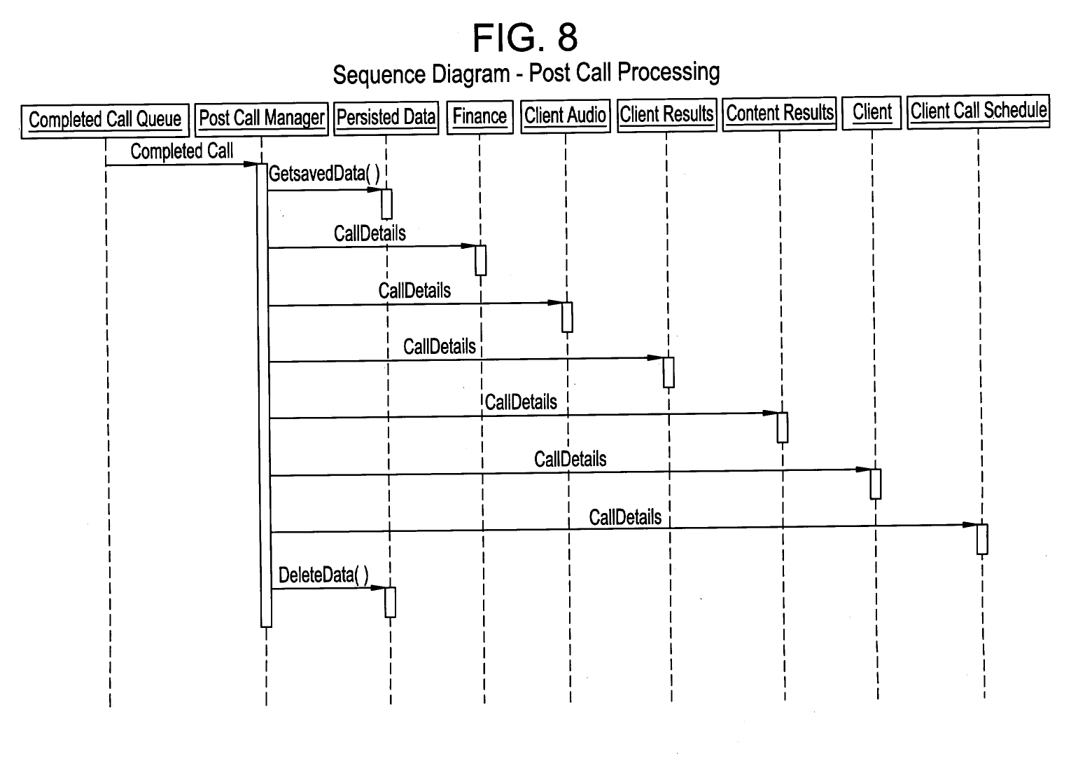

FIGS. 5-8 show a series of sequence diagrams illustrating processes executed by the system discussed with respect to FIGS. 3 and 4. These diagrams show the processing sequence from call profile maintenance through to post call processing. Aspects of the present invention have been described by way of example only and it should be appreciated that modifications and additions may be made thereto without departing from the scope thereof as defined in the appended claims.

What we claim is:

1. A method of transmitting information using an information transmission system adapted to transmit information to a plurality of subscribers, wherein the information transmission system executes the steps of;
(i) receiving at least one electronic transmission of source information from at least one content provider, wherein the source information incorporates a plurality of subscriber details and content information, and
(ii) initiating a telephone call to each of the plurality of subscribers detailed to deliver at least a portion of the content information supplied.

2. A method of transmitting information as claimed in claim 1 wherein source information is transmitted using internet protocols and/or facsimile calls.

3. A method of transmitting information as claimed in claim 1 wherein at least a portion of the source information is received verbally through a telephone call with the content provider.

4. A method of transmitting information using an information transmission system adapted to transmit information to a plurality of subscribers, wherein the information transmission system executes the steps of;
(i) receiving text based source information from at least one content provider wherein the source information incorporates a plurality of subscriber details and content information, and
(ii) initiating a telephone call to each of the plurality of subscribers detailed to deliver at least a portion of the content information supplied.

5. A method of transmitting information as claimed in claim 4 wherein at least a portion of said text based source information is translated into audio speech signals prior to delivery to a subscriber.

6. A method of transmitting information as claimed in claim 4 wherein said system is adapted to transmit at least a portion of the received source information from a single content provider to a plurality of subscribers.

7. A method of transmitting information as claimed in claim 4 wherein the information transmission system includes computer software adapted to transmit source information received from a single content provider to a plurality of subscribers.

8. A method of transmitting information as claimed in claim 4 wherein subscriber details indicate how transmissions are being made to subscribers.

9. A method of transmitting information as claimed in claim 4 wherein subscriber details include subscriber names and telephone numbers.

10. A method of transmitting information as claimed in claim 4 wherein content information includes requests to be delivered to subscribers.

11. A method of transmitting information as claimed in claim 10 wherein subscribers provide an audio response to a request proposed within said content information delivered.

12. A method of transmitting information as claimed in claim 11 wherein the system includes voice recognition software adapted to translate audio subscriber responses into text format responses.

13. A method of transmitting information as claimed in claim 10 wherein subscriber responses to requests are provided through key presses on a telephone keypad.

14. A method of transmitting information as claimed in claim 4 wherein content information is composed of a plurality of discreet portions.

15. A method of transmitting information as claimed in claim 14 wherein a response from subscribers to a request within said content information controls which portions of said content information are delivered to the responding subscriber.

16. A method of transmitting information as claimed in claim 10 wherein requests made to subscribers include requests for task information.

17. A method of transmitting information as claimed in claim 16 wherein task information consists of details of a goal a subscriber has assigned to themselves.

18. A method of transmitting information as claimed in claim 16 wherein the system includes a facility to record task information supplied by a subscriber.

19. A method of transmitting information as claimed in claim 18 wherein the information transmission system includes the facility to replay previously recorded task information to the subscriber at a later time.

20. A method of providing an inspirational service using content supplied from a content provider to a plurality of subscribers characterised by the steps of;
(i) instigating a call to a subscriber, and
(ii) delivering at least one inspirational message to said subscriber wherein said inspirational message or messages are sourced from information provided by said content provider.

21. A method of providing an inspirational service as claimed in claim 20 further characterised by the additional subsequent steps of;
(iii) requesting goal specific information from the subscriber called, and
(iv) recording the subscriber's response to said request for goal specific information.

22. A method of providing an inspirational service as claimed in claim 21 further characterised by the additional subsequent step of;
(v) delivering the subscribers recorded response to a request for goal specific information back to said subscriber at a later time.
